(19) United States
(12) Patent Application Publication
(10) Pub. No.: US 2016/0027322 A1
(43) Pub. Date: Jan. 28, 2016

(54) COGNITIVE-SKILLS TRAINING SYSTEM

(71) Applicant: Summers & Company, Silver Spring, MD (US)

(72) Inventor: Timothy Corneal Summers, Silver Spring, MD (US)

(21) Appl. No.: 14/810,934

(22) Filed: Jul. 28, 2015

Related U.S. Application Data
(60) Provisional application No. 62/029,644, filed on Jul. 28, 2014.

(51) Int. Cl. G09B 19/00; A63F 13/31; A63F 13/23; G09B 5/02; A63F 13/80

(52) U.S. Cl. CPC G09B 19/00; G09B 5/02; A63F 13/80; A63F 13/23; A63F 13/31

(57) ABSTRACT

A cognitive-skills training system and method, having a user interface configured to receive input information from a user via a user computing device in communication with the system, a game engine in communication with the user interface and configured to perform one or more cognitive-skills activities and games on the user using the input information received from the user, an engine application programming interface corresponding to the game engine and configured to provide an application platform for performance of the cognitive-skills games and activities via the game engine, and a processor in communication with the game engine, and configured to receive and process data from the game engine.

### BACKGROUND OF THE INVENTION

1. Field of the Invention

The present invention relates to a cognitive-skills training system and a method thereof. In particularly, the present invention relates to a cognitive-skills training system which assesses, monitors, trains and enhances the cognitive-skills of a user by performing a series of user-specific cognitive-skills activities and games.

2. Description of the related art.

Today, there are age-related brain conditions such as Alzheimer's disease (AD) and other forms of dementia which involve a progressive decline in multiple domains of cognitive function. These conditions may typically lead to an inability of a person to maintain a normal life.

Early detection is critical in such progressive conditions because early treatment is considered more effective in preservation of cognitive skills than later treatment. Further, early detection of the progressive condition may allow room to explore options which may be suitable specifically for the person.

Conventionally, tests including such assessments as scale rating and questionnaires are typically performed on a person, in order to determine whether the person tests positive for the progressive condition. These tests often fail to test for certain types of memory loss associated with early signs of AD, for example, or mild cases of dementia and also fail to employ a monitoring function which can accurately and continuously assess the person's symptoms, and therefore the tests also fail to train and enhance the person's cognitive-skills.

### SUMMARY OF THE INVENTION

The present invention relates to a cognitive-skills training system which is a computer-based system that includes an interactive training feature such as web-based applications and video games to provide stimuli to a user in an intensive, repetitive, adapted and highly targeted manner, to thereby assess, monitor, train and enhance the user's cognitive skills.

The present invention provides a cognitive-skills training system that includes a cognitive-skills training system and method, having a user interface configured to receive input information from a user via a user computing device in communication with the system, a game engine in communication with the user interface and configured to perform one or more cognitive-skills activities and games on the user using the input information received from the user, an engine application programming interface corresponding to the game engine and configured to provide an application platform for performance of the cognitive-skills games and activities via the game engine, and a processor in communication with the game engine, and configured to receive and process data from the game engine.

The present invention provides a method implemented by computer system to effect performance of cognitive-skills training using the above-identified system, and a computer readable medium implementing the method.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is a block diagram of a cognitive-skills training system that can be implemented within one or more embodiments of the present invention.

FIG. 2 is a block diagram of a user interfacing with the cognitive-skills training system that can be implemented within one or more embodiments of the present invention.

FIG. 3 is an architectural layout of the cognitive-skills training system that can be implemented within alternative embodiments of the present invention.

FIG. 4 is a flowchart illustrating a method of performing cognitive-skills training that can be implemented within one or more embodiments of the present invention.

FIG. 5 is a block diagram of an exemplary computing device illustrating components of the user device and components of the cognitive-skills training system that can be implemented within one or more embodiments of the present invention.

FIG. 6 is a block diagram of an exemplary physical storage system for implementation of the data repository of the cognitive-skills training system in accordance with one or more embodiments of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Specific details are given in the following description to provide a thorough understanding of the embodiments. However, it will be understood by one of ordinary skill in the art that the embodiments may be practiced without these specific details. For example, systems, networks, processes, and other components may be shown as components in block diagram form in order not to obscure the embodiments in unnecessary detail. Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The present invention as will be described in greater detail below provides a cognitive-skills training system for performing cognitive-skills activities and games on a user via a user interface in order to assess, monitor, train and enhance the user's cognitive-skills. The cognitive-skills activities and games are adaptable based on the user's cognitive skill level and are therefore user-specific. The present invention provides various embodiments as described below. However it should be noted that the present invention is not limited to the embodiments described herein, but could extend to other embodiments as would be known or as would become known to those skilled in the art. According to one or more embodiments, the cognitive-skills training system 100 may be implemented for use in progressive condition screening (e.g., Alzheimer's and dementia screening), clinical trials, driver's safety testing, rehabilitation, academic research, concussion analysis and management, classroom learning, self-assessment, brain training and employment assessment, and other training such as cybersecurity training and innovative thinking training.

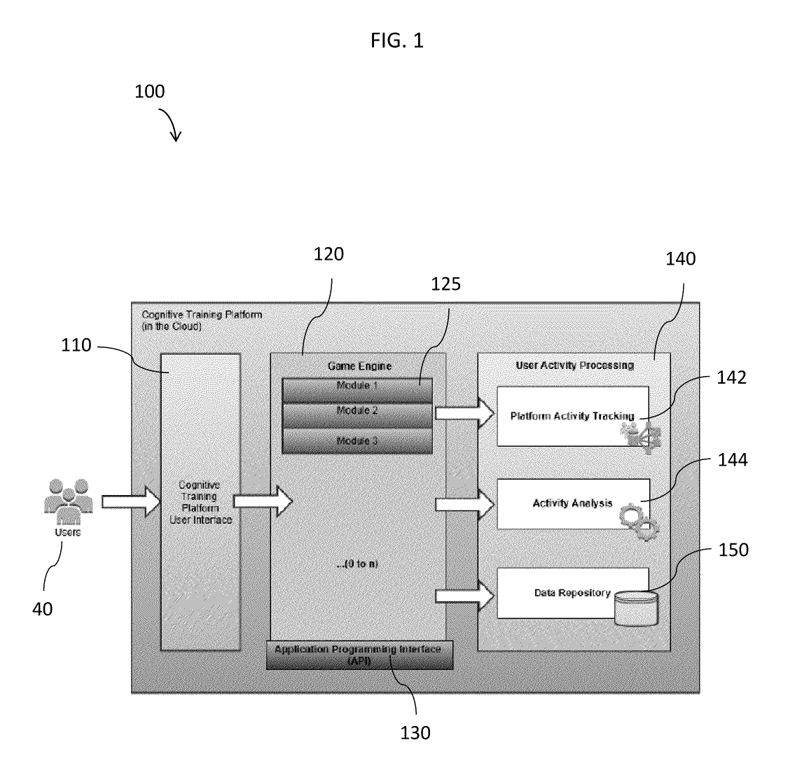

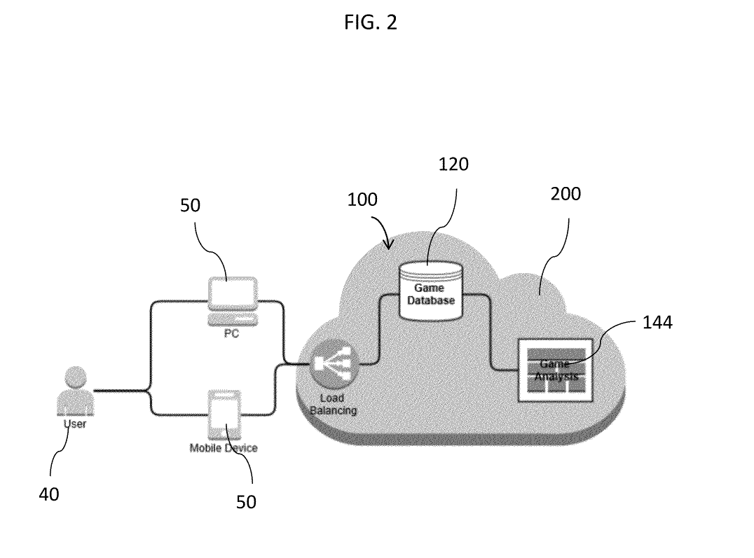

FIG. 1 is a block diagram of a cognitive-skills training system 100 implemented within one or more embodiments of the present invention. FIG. 2 is a block diagram of a user 40 interfacing with the cognitive-skills training system 100 that can be implemented within one or more embodiments of the present invention. The present invention will be described in reference to FIGS. 1 and 2.

A user 40 at a user computing device 50 (as depicted in FIG. 2) accesses the cognitive-skills training system 100, via a communication network such as the Internet. According to one or more embodiments, the user computing device 50 includes at least one of a mobile device or smart phone, a personal computer or laptop, or a personal digital assistant (PDA) or tablet. The present invention is not limited to any particular type of user computing device 50, and may vary accordingly.

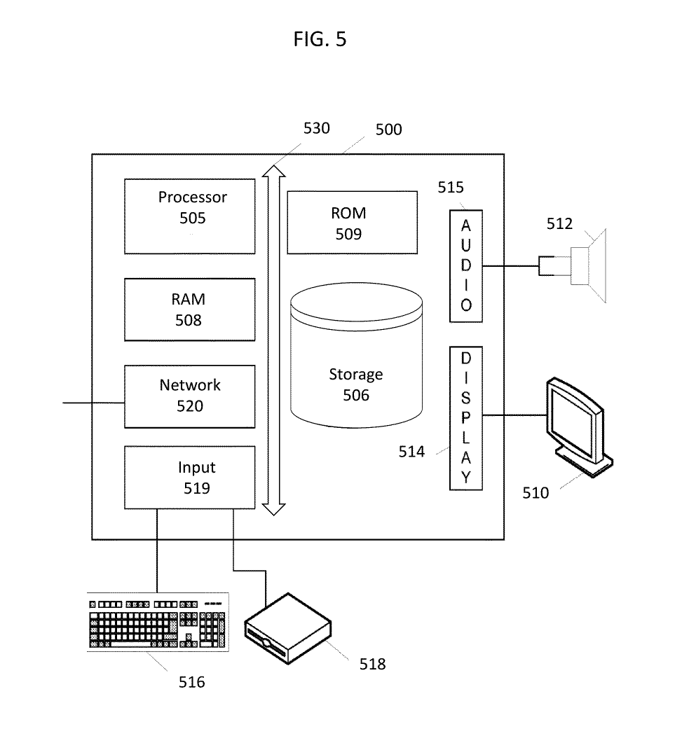

FIG. 5 is a block diagram of an exemplary computing device 500 illustrating components of the computing device 50 and of the system 100. As shown in FIG. 5, the computing device 500 includes various components for inputting, outputting, storing and processing data. The computing device 500 includes a processor 505 for performing tasks including executing one or more applications, retrieving data from a storage device e.g., storage 506, and/or outputting data. The processor 505 can be connected to a Random access memory (RAM) module 508 wherein application data and/or instructions may be temporarily stored. The computing device 500 can further includes a Read Only Memory (ROM) 509 configured to allow data stored thereon to persist after the computing device 500 is turned off and is used for storing an operating system (OS) of the computing device 500. The storage device 506 may also provide storage for data files and may include computer readable mediums e.g., disk drives, optical storage mediums e.g., CD ROM drives, magnetic tape storage systems, and flash memory. The processor 505 is configured to retrieve an application from the storage 506 and store the instructions associated with the application in the RAM module 508, while the processor 505 is executing the application. The computing device 500 further includes output devices e.g., a display device 510, and a speaker 512, for outputting visual and audio data via a display adapter 514 and an audio adapter 515. Further, the computing device 500 includes input devices e.g., a keyboard 516, a storage media drive 518, and microphone each having an associated adapter 519 for converting the input data into computer readable data. The storage media drive 518 enables users to read and write data to and from the storage media.

Further, as shown in FIG. 5, the computing device 500 includes one or more components for receiving and transmitting data over the communication network. For example, a network adapter 520 is provided for communication with one or more computing devices over an IP network, for example, for transmission of data. The network adapter 520 may include instructions associated with processing IP network packets and cellular network packets. The components of the computing device 500 are connected via a system bus 530.

Referring back to FIGS. 1 and 2, according to one or more embodiments, the cognitive-skills training system 100 may be in a cloud platform 200, wherein the user 40 accesses the system 100 via a web-application at the user computing device 50. The web application may correspond to multiple application services, web servers and data servers which are employed using automated load balancing to thereby accommodate multiple users 40 simultaneously.

The user 40 accesses system 100 by inputting input data including identification and log-in information such as a user ID and password via a user interface (UI) 110 of the system 100 via an input device (e.g., a keyboard or touch display) at the user computing device 50. Once the identification/log-in information is received at the system 100, the system 100 retrieves the user's entered information and/or previously stored information and displays the information via a display of the user computing device 50. The system 100 is configured to receive the input data and provide the user with information over the communication network.

The communication network may include a wired or wireless network for data communication. The data communication across communication network may be achieved by using web services technology including for example, Web services Description Language (WSDL). The communication network may include any subsystem for exchanging data such as the Internet, intranet, extranet, wide area network (WAN), local area network (LAN), Restful web services, JAVAScript Object Notation (JSON), Extensible Mark-up Language (XML)-based communication network, Simple Object Access Protocol (SOAP)-based Services and satellite communication network. Further, the communication network may be other types of networks such as interactive television (ITV). Accordingly, multiple users may be able to access the system 100 via multiple different types of communication networks.

The system 100 is a user-specific system and allows each user 40 to have a secure access to their personal information and cognitive-skills related activities and games by establishing a user profile for the system 100 and therefore all or any portion of the user's data may be stored within the system 100 (e.g., at the data repository 150 therein).

The game engine 120 comprises a plurality of software modules 125 from 1 to n, wherein n is equal to or greater than 1. Each software module 125 is configured to perform a specific cognitive-skills activity 126 or game 128. The game engine 120 further comprises a specific application programming interface (API) 130 which is a set of programming instructions and standards for accessing—a web-based software application or tool. The API 130 is released by system 100 and configured to allow other software developers to create activities and games for the system 100. According to an embodiment, the API 130 is a software-to-software interface.

Further, according to some embodiments of the present invention, the game engine 120 is accessed via the user interface 110 through a web browser of the user computing device 50 and does not require downloading and installing thereof onto the user computing device 50. Alternatively, according to other embodiments, the system 100 may require the user to access and download some software to the user computing device 50.

According to one or more embodiments, the software modules 125 may each include cognitive-skills activities and games each targeting specific cognitive skills using unique experiences that challenge the brain and create new and more efficient neural connections. The specific cognitive skills may include but are not limited to one or more of visual processing, processing speed, reading, attention, memory, logic and reasoning, creativity, inquisitive thinking, problem solving, mind mapping, cognitive flexibility, ambiguity tolerance, reflective thinking and forward thinking. The cognitive-skills games and activities may include known games (e.g., such as word matching, Lost in Migration, Memory Matrix and Speed Match, newly created games, and/or user-specific games According to one or more embodiments, the activities and games are adaptive such that as the user 40 successfully completes levels of the activities and games the level of difficulty increases. Thus, for each user, the difficulty level is based on their progress.

According to one or more embodiments, in system 100, the users 40 are able to build their own user-specific cognitive development program based on the cognitive skills they want to focus on during their training. In the user-specific cognitive development program, the user 40 sets goals for specific cognitive skills they wish to improve.

Upon completion of the activities and games at the respective modules 125, the performance of the activities and games is measured and tracked via the processor 140 in communication with the game engine 120. The processor 140 is a user activity processor configured to measure, monitor and analyze the user's 40 activity and performance within the system 100. The measuring operation may be performed using a cognitive skills performance index (CSPI), for example, which is an aggregate measure of performance of the activities and games that allows the user 40 to track their improvement in multiple areas such as speed, memory, attention, flexibility and problem solving, for example.

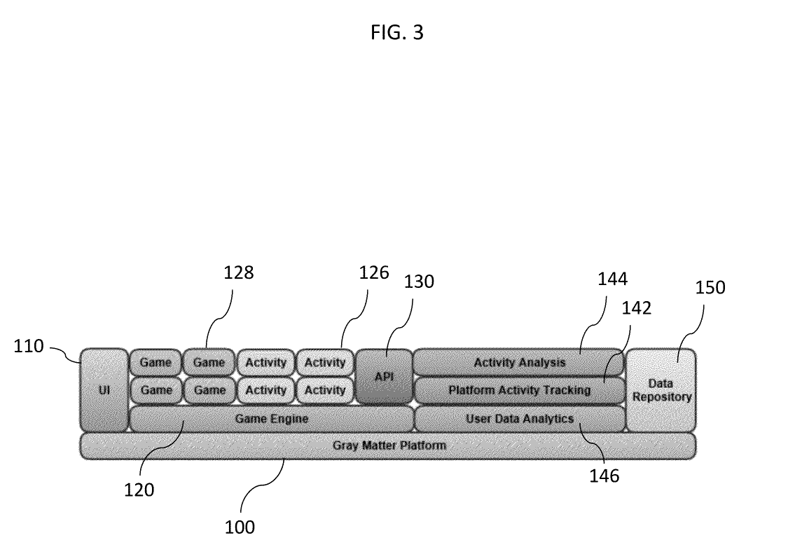

The processor 140 includes multiple modules for performing the tracking and analyzing of the resulting data of the user 40. According to one or more embodiments, these modules may include a platform activity tracking module 142 configured to monitor or track the number of specific activities and games being performed by each user 40, an activity/game analysis module 144 which is configured to analyze user performance regarding each activity and game performed in modules 125, and a user data analytics module 146 (as depicted in FIG. 3) which is configured to capture user data including data associated with the cognitive-skills activities and games performed by all users 40 of the system 100 and enable comparison data to be generated purposes of analysis by a respective user or other third parties. For example, according to one or more embodiments, the user 40 may view an individualized dashboard via the user computing device 50 which shows the standing of the respective user 40 in the overall distribution of users 40 an relative to users 40 having similar training goals and priorities as that of the respective user 40.

All of the data received may be stored within the data repository 150 as shown in FIG. 1.

The data may be used to provide a score and reward system to encourage user participation, wherein as points are accrued by the user 40, the user 40 receives rewards (e.g., achievement recognition and trophies) within the system 100.

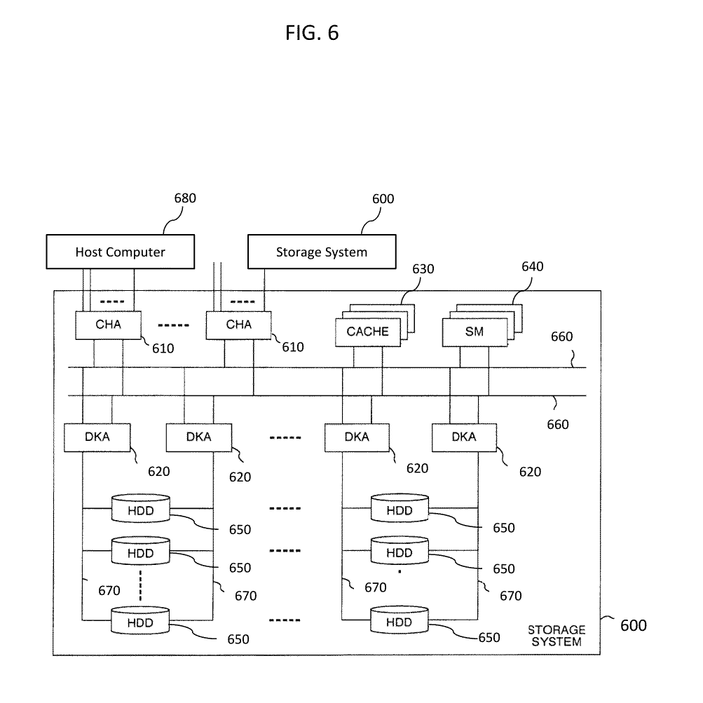

Further, the data may also be used to generate analysis reports for the users 40 and other parties which include specific dates of training, total activities completed and changes in user performance ratings (e.g., CSPI). The reports may be generated in any type of format, such as bar graphs, charts, and other visualizations. FIG. 6 is a block diagram of an exemplary physical storage system 600 for implementation of the data repository 150 of the system 100 in accordance with one or more embodiments of the present invention.

As shown in FIG. 6, the physical storage system 600 includes a plurality of host adapters (CHA) 610, disk adapters (DKA) 620, cache memories (CACHE) 630, shared memories (SM) 640, and hard disk drives (HDD) 650 connected with each other via common paths 660 and connection lines 670. Each of the hard disk drives (HDD) 650 is connected to two disk adapters 620, for example, using different connection lines 670. The host adapters 610 control data transfer between host computers 680, the cache memories 630 and the hard disk drives 650. The cache memories 630 temporarily store data received from the host computer 680 and data read from the hard disk drives 650. The shared memories 640 are shared between the host adapters 610 and the disk adapters 620. The present invention is not limited to any particular number of host adapters 610, disk adapters 620, cache memories 630, shared memories 640 and hard disk drives 650, and may vary accordingly. The physical storage system 600 is one example of a physical storage system for which the data repository 150 can be implemented thereon. The present invention is not limited to a particular configuration of the physical storage system. According to other embodiments, the hard disk drives (HDD) 650 can be replaced with a flash storage, RAM disks or rotated disk drives, for example. The host computers 680 can be the processor 124 or a separate computer, for example. Further, the data repository 150 of the system 100 can be implemented on any type of storage system such as a network-attached storage (NAS), a storage area network (SAN), or a distributed memory array.

According to one or more embodiments, the physical storage devices of the physical storage system 600 as described above can be configured in a RAID (Redundant Array of Independent Disks) configuration.

According to another embodiment of the present invention, subscription membership may be implemented within the system 100 to allow individuals and/or groups or organizations to subscribe to use the system 100 based on a standard pricing scheme. Further, access to the data of the system 100 may be accessed by researchers, government agencies, and other interested organizations based on a subscription membership to the system 100.

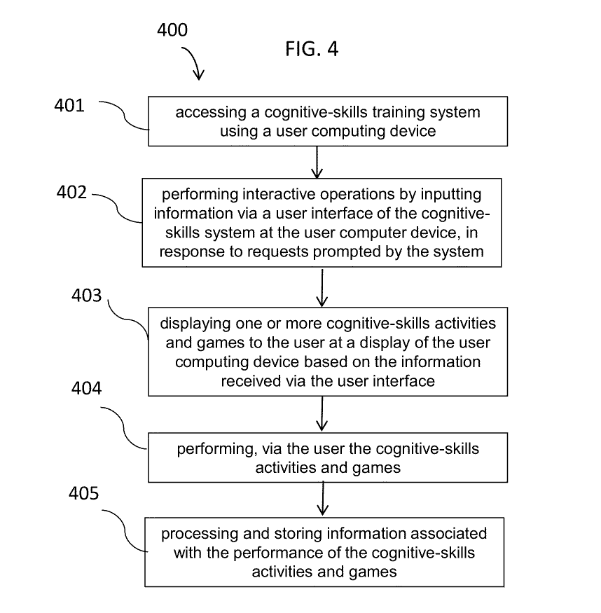

An operation of the system 100 via a user 40 at the user computing device 50 will now be described with reference to FIG. 4. FIG. 4 is a flowchart illustrating a method of performing cognitive-skills training that can be implemented within one or more embodiments of the present invention. The method 400 is implemented in software modules for execution by the user computing device 50 and within the system 100. In method 400, the system 100 interfaces with the user computing device 50. At operation 401, the system 100 establishes a connection with the user computing device 50 based on verification of the user's 40 log-in information and accessing the system 100 using a user computing device 50.

From operation 401, the process continues to operation 402 where interactive operations are performed by inputting information via the user interface 110 of the system 100 at the user computer device 50, in response to requests prompted by the system 100. The user 40 is prompted to input information based on requests made by the system. The requests may include name, age, and birth date information, for example of the user. The requests may further include interests and occupation information of the user 40. The game engine 120 receives the user information at operation 403, and analyzes the user information and displays one or more cognitive-skills activities 126 and games 128 to the user 40 at a display of the user computing device 50 based on the information received via the user interface 110.

If the user 40 has previously accessed the system 100, at operation 403, the system 100 may provide the user 40 with an option to continue where left off within their previously created training program, provide the user 40 with results from their last session within the system 100, or prompt the user 40 to continue on at the next level within the system 100.

At operation 404, the user 40 plays/performs the cognitive-skills activities 126 and games 128. And from operation 404, the process continues to operation 405 where data is processed via the processor 140 and distributed with the respective modules 142, 144 and 146 for processing. Further, the data is also transmitted and stored within the data repository 150, for further use and access by individuals and other parties for research, etc.

According to one or more embodiments, as a part of the training process, the user 40 may perform the cognitive-skills activities 126 and games 128 repetitively to enhance his/her cognitive-skills. Alternative, the user 40 may be advanced from one level to another level based on the user's successful completion of levels within a respective cognitive-skills activity 126 or game 128.

In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the invention. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

Embodiments of the present invention provide a cognitive-skills training system that includes a user interface configured to receive input information from a user via a user computing device in communication with the system, a game engine in communication with the user interface and configured to perform one or more cognitive-skills activities and games on the user using the input information received from the user, an engine application programming interface corresponding to the game engine and configured to provide an application platform for performance of the cognitive-skills games and activities via the game engine, and a processor in communication with the game engine, and configured to receive and process data from the game engine.

Further, embodiments of the present invention provide a method implemented by computer system to effect performance of cognitive-skills training, the method comprising accessing a cognitive-skills training system using a user computing device, performing interactive operations by inputting information via a user interface of the cognitive-skills system at the user computer device, in response to requests made by the system, displaying one or more cognitive-skills activities and games to the user at a display of the user computing device based on the information received via the user interface, performing, via the user the cognitive-skills activities and games, and processing and storing information associated with the performance of the cognitive-skills activities and games.

Further yet still, embodiments of the present invention provide a computer readable medium storing computer executable instructions that, when executed, cause a computing device to perform a method for performing cognitive-skills training, the method comprising accessing a cognitive-skills training system using a user computing device, performing interactive operations by inputting information via a user interface of the cognitive-skills system at the user computer device, in response to requests made by the system, displaying one or more cognitive-skills activities and games to the user at a display of the user computing device based on the information received via the user interface, performing, via the user the cognitive-skills activities and games, and processing and storing information associated with the performance of the cognitive-skills activities and games.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A cognitive-skills training system comprising:
a user interface configured to receive input information from a user via a user computing device in communication with the system;
a game engine in communication with the user interface and configured to perform one or more cognitive-skills activities and games on the user using the input information received from the user;
an engine application programming interface corresponding to the game engine and configured to provide an application platform for performance of the cognitive-skills games and activities via the game engine; and
a processor in communication with the game engine, and configured to receive and process data from the game engine.

2. The system of claim 1, wherein the system is a cloud-based system.

3. The system of claim 1, wherein the game engine comprises a plurality of game engine software modules, each module corresponding to a cognitive-skill activity or game to be performed by the user.

4. The system of claim 1, wherein the API is an internet-enabled application.

5. The system of claim 1, wherein the system is configured to allow the user to build a user-specific cognitive skills development program based on the cognitive skills the user desires to focus on during cognitive-skills training.

6. The system of claim 3, wherein the processor comprises multiple processor software modules configured to monitor and analyze data received from the game engine.

7. The system of claim 6, wherein the multiple processor software modules comprises:
a platform activity tracking module configured to monitor a number of specific cognitive-skills activities and games being performed by each user;
an activity/game analysis module configured to analyze user performance regarding each cognitive-skills activity and game performed within the game engine software modules; and
a user data analytics module configured to capture user data including data associated with the cognitive-skills activity and game performed by a plurality of users of the system.

8. The system of claim 6, further comprising a data repository configured to store the data received from the game engine.

9. The system of claim 8, further comprising a subscription membership program, wherein the data stored in the data repository is accessible to users and other parties via membership to the subscription membership program.

10. A method implemented by computer system to effect performance of cognitive-skills training, the method comprising:
accessing a cognitive-skills training system using a user computing device;
performing interactive operations by inputting information via a user interface of the cognitive-skills system at the user computer device, in response to requests prompted by the system;
displaying one or more cognitive-skills activities and games to the user at a display of the user computing device based on the information received via the user interface;
performing, via the user the cognitive-skills activities and games; and
processing and storing information associated with the performance of the cognitive-skills activities and games.

11. The method of claim 10, wherein performing interactive operations by inputting information via a user interface of the cognitive-skills system at the user computer device further comprising monitoring and analyzing data input information received.

12. The method of claim 10, further comprising building a user-specific cognitive skills development program based on the cognitive skills the user desires to focus on during cognitive-skills training.

13. The method of claim 10, wherein processing and storing information associated with the performance of the cognitive-skills activities and games further comprises:
monitoring a number of specific cognitive-skills activities and games being performed by a plurality of users;
analyzing user performance regarding each cognitive-skills activity and game performed within the game engine software modules for each user;
capturing user data including data associated with the cognitive-skills activity and game performed by the plurality of users;
storing the captured user data in a data repository storing data for the plurality of users.

14. The method of claim 13, wherein the data repository storing data for the plurality of users is accessed and performs operations user data stored therein through an application program interface (API) for cognitive skills training.

15. A non-transitory computer-readable storage medium, which stores computer-executable instructions to implement cognitive skills training on a game server, wherein if executed by a computing device, the computer-executable instructions cause the computer device to perform operations comprising:
accessing a cognitive-skills training system using a user computing device;
performing interactive operations by inputting information via a user interface of the cognitive-skills system at the user computer device, in response to requests prompted by the system;
displaying one or more cognitive-skills activities and games to the user at a display of the user computing device based on the information received via the user interface;
performing, via the user the cognitive-skills activities and games; and
processing and storing information associated with the performance of the cognitive-skills activities and games.

16. The computer-readable storage medium of claim 15, wherein performing interactive operations by inputting information via a user interface of the cognitive-skills system at the user computer device further comprising monitoring and analyzing data input information received.

17. The computer-readable storage medium of claim 15, further comprising building a user-specific cognitive skills development program based on the cognitive skills the user desires to focus on during cognitive-skills training.

18. The computer-readable storage medium of claim 15, wherein the processing and storing information associated with the performance of the cognitive-skills activities and games further comprises:
monitoring a number of specific cognitive-skills activities and games being performed by a plurality of users;
analyzing user performance regarding each cognitive-skills activity and game performed within the game engine software modules for each user;
capturing user data including data associated with the cognitive-skills activity and game performed by the plurality of users;
storing the captured user data in a data repository storing data for the plurality of users.

19. The computer-readable storage medium of claim 18, wherein the data repository storing data for the plurality of users is accessed and performs operations user data stored therein through an application program interface (API) for cognitive skills training.

20. The computer-readable storage medium of claim 15, wherein the computing device is part of a cloud-based system.
